(19) United States
(12) Patent Application Publication
(10) Pub. No.: US 2003/0110114 A1
(43) Pub. Date: Jun. 12, 2003

(54) Online capital approval process

(75) Inventors: Cynthia Florence Dmochowski, Wyomissing, PA (US); Jacob R. Kimball, Whitehall, PA (US); Scott A. Margerum, Hellertown, PA (US); Nelson LeRoy Fernandez, Mecungie, PA (US)

Correspondence Address: Lester H. Birnbaum, 6308 Sauterne Drive, Macungie, PA, 18062, US

(73) Assignee: Agere Systems Inc.

(21) Appl. No.: 10/010,656

(22) Filed: Dec. 6, 2001

(51) Int. Cl. G06F 17/60

(52) U.S. Cl. 705/36

(57) ABSTRACT

An online system centralizes and streamlines the capital expenditure approval process for an organization without requiring the movement of papers from one approver to another. The number of required approvals and the identity of the approving persons is determined in advance. When an employee initiates a request to purchase equipment, his online identification of his department, the nature of the requested purchase, and the purchase price causes the online system to automatically notify the appropriate approvers that they must make a decision. If an approver denies approval, the requesting employee is immediately notified and is given an opportunity to provide additional information. Everyone is automatically notified when the purchase is finally approved by everyone.

### BACKGROUND OF THE INVENTION

1. Field of the Invention

The present invention relates generally to online transactions and more particularly to the manner of entering requests for capital expenditures and having them routed to the appropriate approver persons.

2. Brief Description of the Prior Art

In large organizations, employees often have a need to purchase large quantities of supplies or to otherwise ask the organization to make substantial capital expenditures for various projects. The organizations often have an approval process which requires the approval of such expenditures on many managerial levels.

Up until now, the capital approval process comprised the hand transmittal of papers to the various managers whose approvals were needed. The process began when an employee completed a written form requesting a capital expenditure. The request form would then slowly move through the approval process so that eventually all appropriate managers individually reviewed the request and individual managers either approved it or disapproved it. This process was very slow and paper intensive. Because multiple managerial levels must often approve these capital requests, passing the papers and/or passing emails and sequential approvals from one level to another was cumbersome and created several costly problems.

In addition, the employees who submitted the requests had limited means of tracking their requests in order to determine quickly which managers had given approvals and which managers had not done so. The only way an employee could make the determination was to call all of the people in each step of the approval process. Even then, the employee could not easily determine who had approved the request or where in the approval process the request was located. The employee's attempt to determine the status of a request could be hampered, for example, by structural or organizational changes within the company or by personnel changes due to resignations or reassignments. In addition, after a request was approved, the employee did not always receive the information necessary to make the expenditure and to close the request. The lack of appropriate and timely notification prevented employees from correctly charging, billing, and closing orders which, in turn, lead to inaccurate accounting, depreciation, and incorrect statements of financial results.

In the past, attempts have been made to increase the speed and efficiency of the capital approval process. However, these endeavors were unsuccessful because they attempted to work within the confines of the paper process. The same problems of inefficiency and inaccuracy plagued the new variations of the old paper process. The old paper process was cumbersome and inefficient because the request had to be passed to multiple levels in the approval chain. The cycle time took longer than necessary. The engineer requesting the capital expenditure had no meaningful way of tracking his request and often did not receive an appropriate and timely notification of approval.

These attempts did not create an efficient and reliable means of obtaining the necessary approval for capital expenditure requests.

Accordingly, there is a need for a system which allows an employee to efficiently and accurately track a request for a capital expenditure and to monitor the approval process.

### SUMMARY OF THE INVENTION

The present invention discloses a system which fully automates the capital expenditure approval process. In the embodiments disclosed herein, one advantage is that an online system can be created which fully automates the capital expenditure approval process by centralizing the approval process, notifying everyone in the approval chain about their obligation to make a decision, allowing the employees to track the approval process, notifying the employees when final approval has been given, and affording the ability to search old requests.

### BRIEF DESCRIPTION OF THE DRAWINGS

FIG. 1 is a block diagram showing one embodiment of the flow of information in accordance with the present invention.

FIG. 2 is an embodiment of an online form prepared by an employee describing the item to be purchased.

FIG. 2A is an embodiment of an expanded drop down version of block 28 in FIG. 2.

FIG. 3 is an embodiment of an approval screen.

FIG. 3A is an embodiment of an expanded version of the approval screen shown in FIG. 3.

FIG. 4 is an embodiment of approval chains stored in the database.

FIG. 5 is an embodiment of an email notification sent to approvers.

FIG. 6 is an embodiment of an online status page showing the status of each expenditure request.

FIG. 7 is an embodiment of a final notification form showing final approval.

### DETAILED DESCRIPTION OF THE PREFERRED EMBODIMENTS

The new online system centralizes the capital expenditure approval process to a database in a computer system which saves the requested information, notifies the approvers via email when action is required of them, stores the decision of each approver, notifies the list of users when the request receives final approval, and affords the ability to search old requests. Centralization to a database allows reference, tracking, and storing data while increasing the speed and accuracy of information from the first step of the process to the last. The online system fully automates the capital approval process. As used herein, a computer is construed broadly to include a conventional computer such as commercially available by Dell® with Pentium® or other devices such as without limitation a pager, palm pilot and other device which can store, save, and manipulate information.

The embodiments of this invention allow capital expenditure requests to be processed by entering the request information on-line, storing the information, notifying the approvers via email when action is required of them, tracking current requests, and notifying a list of users when the request is finally approved.

The software system uses a database to store information and drive process workflow for capital expenditures. In one embodiment of the invention, the database is MS Access. But, as will be apparent to those skilled in the art, other databases which operate in the same fashion as MS Access could also be used. For example, other embodiments of the invention could use any Open Database Connectivity (ODBC) compliant database so that software developers can access the databases more easily and without having to use the particular database's native method of connection. Database access, system logic, and user interfaces can be developed in CFML (Cold Fusion Markup Language) because Cold Fusion provides a gateway to ODBC compliant databases along with a set of tools such as email. Such interfacing with a database allows information to be stored and retrieved as needed and also allows all information to be searched and kept for as long as desired. Other embodiments can be used to devise a system which is user request driven.

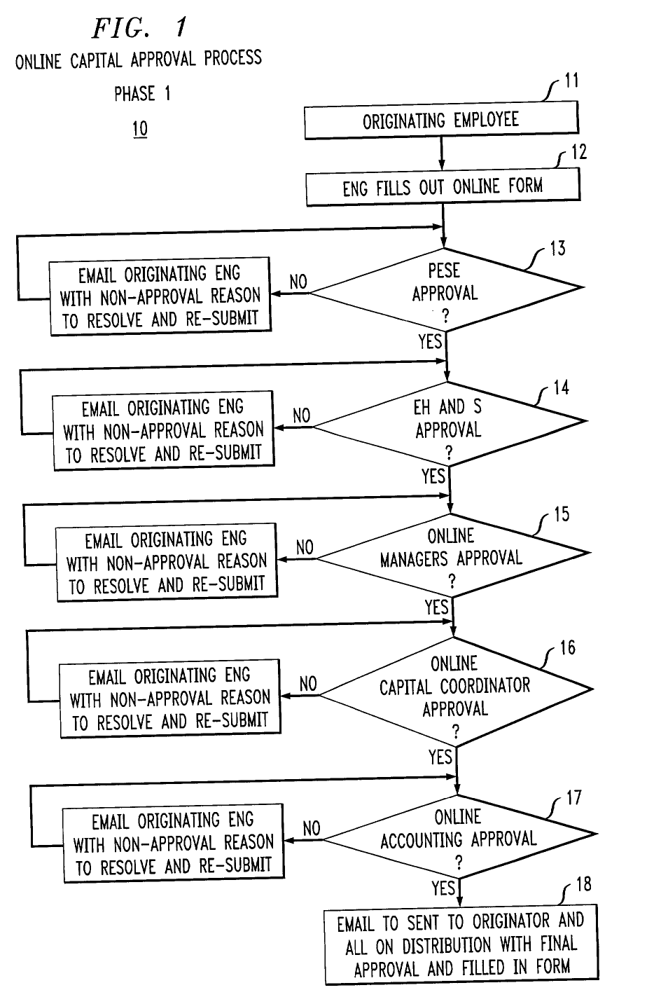

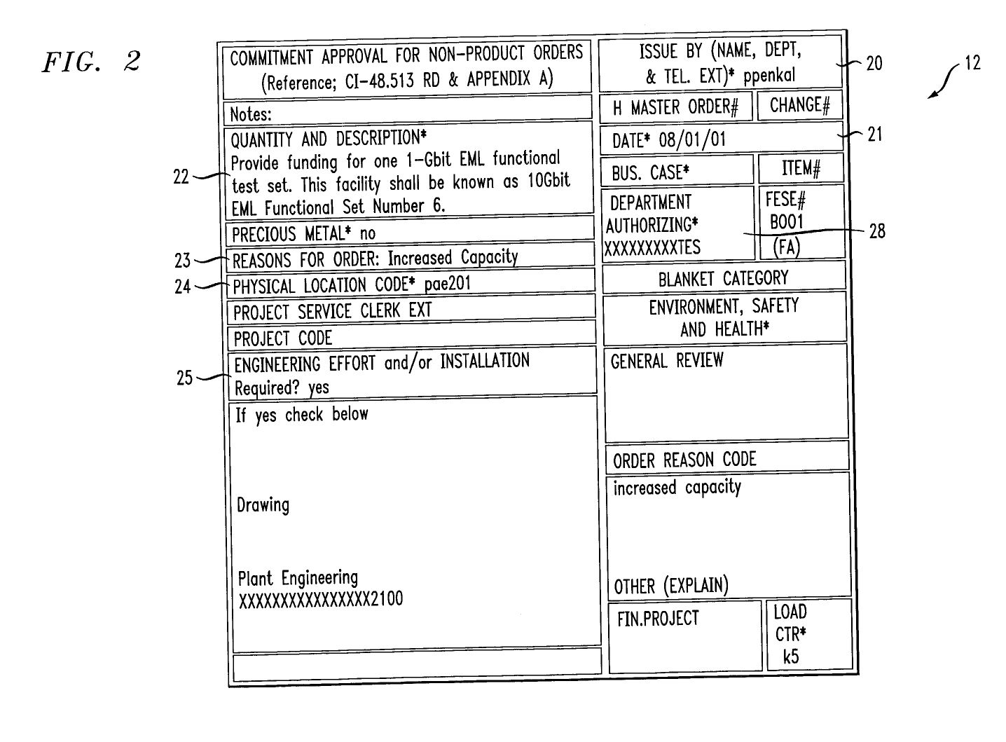

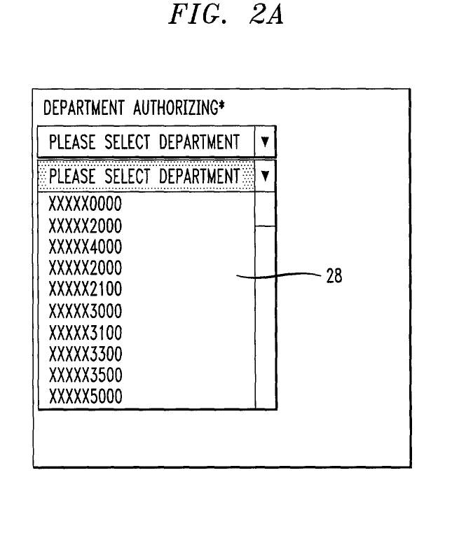

A presently preferred embodiment of an online capital approval process is illustrated in FIG. 1. In this embodiment, the online capital approval process as illustrated preferably operates in the following manner. An originating employee 11 provides information to the database by filling out an online form 12 describing the item which the employee wants to purchase. The form will be described in more detail in connection with FIG. 2. After the information is entered into the database, the database determines which supervisors and managers must give their approvals and begins the process of transmitting the information via Email from form 12 to each of the approvers and notifying each of the approvers that their decision is required.

Therefore, the information on form 12 is automatically transferred to first approver 13. After first approver 13 reviews the information, she may approve or disapprove the purchase and enters the approval or disapproval into the database. If first approver 13 approves the request online, the database causes the information in form 12 to be transmitted to the second necessary approver, approver 14 for decision. If, however, approver 13 does not approve the purchase, she enters the reason(s) for the non-approval and the database automatically and immediately sends an Email notification to the originating employee 11 along with the reasons for disapproval given by approver 13. Employee 11 therefore immediately knows that approver 13 did not approve the purchase and the reasons for the non-approval. Thereafter, employee 11 can enter new information onto form 12 which will satisfy approver 13 and re-submit the form to approver 13.

When approver 14 receives the Email requesting a decision, approver 14 will follow the same procedure previously followed by approver 13. If approver 14 approves the purchase, the database will automatically Email a notification to the next approver, approver 15. If, however, approver 14 disapproves the purchase, an Email will be sent to the originating employee 11 with approver 14's reasons for disapproval and employee 11 can provide the information needed for approver 14's approval, enter it into form 12, and re-submit the form 12. Following the same procedure, the information on form 12 is sent to all of the necessary approvers until they have all approved the purchase or one of them has disapproved the purchase resulting in a non-approval. In the embodiment shown in FIG. 1, approvers 15, 16, and 17 would be notified of the need to make a decision based on the information in form 12. If all of them approve the purchase, the database automatically sends an Email to the originating employee 11 as well as everyone else on the distribution list (approvers 13, 14, 15, 16, 17) with the notification of final approval in the form of a completely filled in form 12. The notification of final approval is shown in block 18.

FIG. 2 illustrates an embodiment of form 12 in FIG. 1. It is the main data entry form which provides the information the approvers need to make their decisions, including the dollar amount they are approving. Form 12 is viewed online by employee 11 who is prompted to enter required fields of information onto form 12. It will be understood by those skilled in the art, that different embodiments of form 12 may be used depending upon the needs of the organization using it. In the embodiment illustrated in FIG. 2, the form requires the name of the originating employee 20, the date 21 the information is entered into the form, a description 22 of the item to be purchased, the reasons 23 for the purchase, the place 24 where the item will be located, the amount of work 25 that will be required to install the item, the total cost 26 associated with purchasing and installing the item, the estimated date 27 when installation of the item will be completed.

As also illustrated in FIG. 2 and FIG. 2A, form 12 requires the employee to identify his/her department of employment 28. As shown in FIG. 2A, the employee selects the department of employment from a preprogrammed drop down list of department choices. Once employee 11 selects the appropriate department from the drop down list in block 28, it is permanently entered onto form 12. The selection of a department from the drop down list is the sole decider of which approvals are required because each of the departments shown at 28 in FIG. 2A are preprogrammed to selected approval chains. In one embodiment of the invention, the approval chains may be based upon the dollar value of the purchase. It will be understood by those skilled in the art that other embodiments may base the number of needed approvals upon other factors such as the type of equipment to be purchased. An embodiment of an approval chain is the approval chain shown in FIG. 1. Therefore, the selection of department 28 automatically designates the approval process and identifies all of the requisite approvers. Accordingly, although FIG. 1 shows five approval levels, the purchase of a different piece of equipment may only require three levels of approval, or four levels of approval.

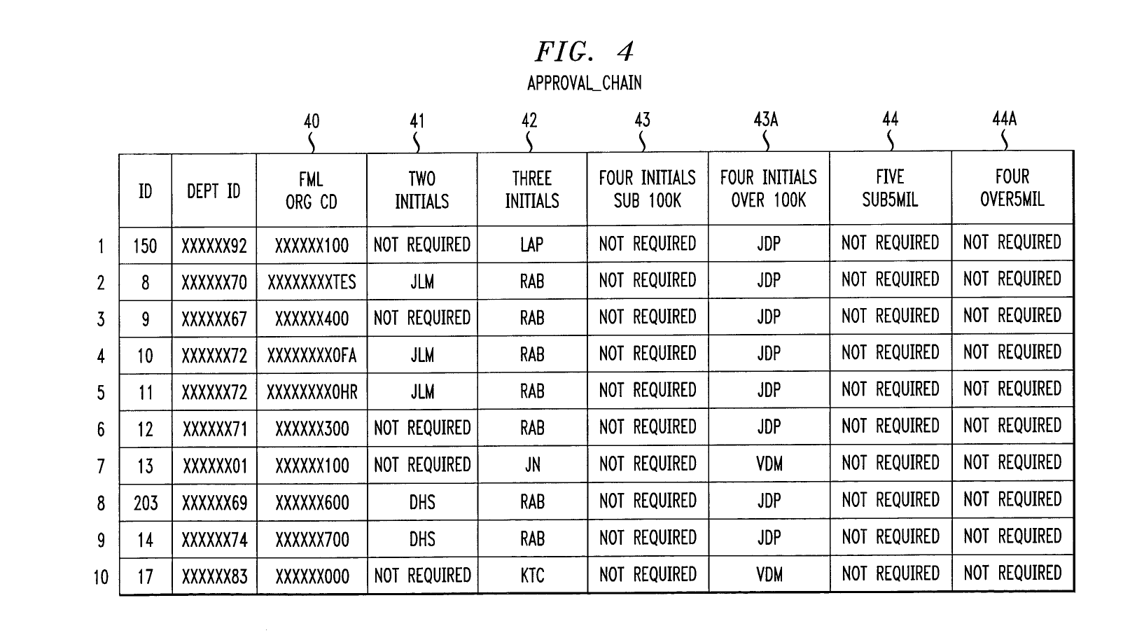

FIG. 4 shows an embodiment of 10 approval chains which are stored in the database. The approval chains are designated as rows 1 to 10. Each row shows five columns 40, 41, 42, 43, 44. The first column 40 identifies the department of the employee making the purchasing request. Columns 41, 42, 43, and 44 specify which persons must approve based upon the type of equipment being purchased and the purchase price of the equipment. Column 41 shows that approval at the first level (corresponding, for example, to approval level 13 in FIG. 1) is not required. Column 42 shows that approval at the second level is required by the person identified as LAP. Columns 43 and 43A show that approval at that level is not required if the purchase is under $100,000; but does require approval at that level if the purchase exceeds $100,000. Similarly, columns 44 and 44A show that approval at that level is not required if the purchase is under $1 million; but does require approval at that level if the purchase exceeds $1 million. Analogous entries are made for the other departments shows in rows 2 through 10 of FIG. 4. It will be understood by those skilled in the art that other embodiments may have greater or fewer numbers of rows and greater or fewer numbers of columns.

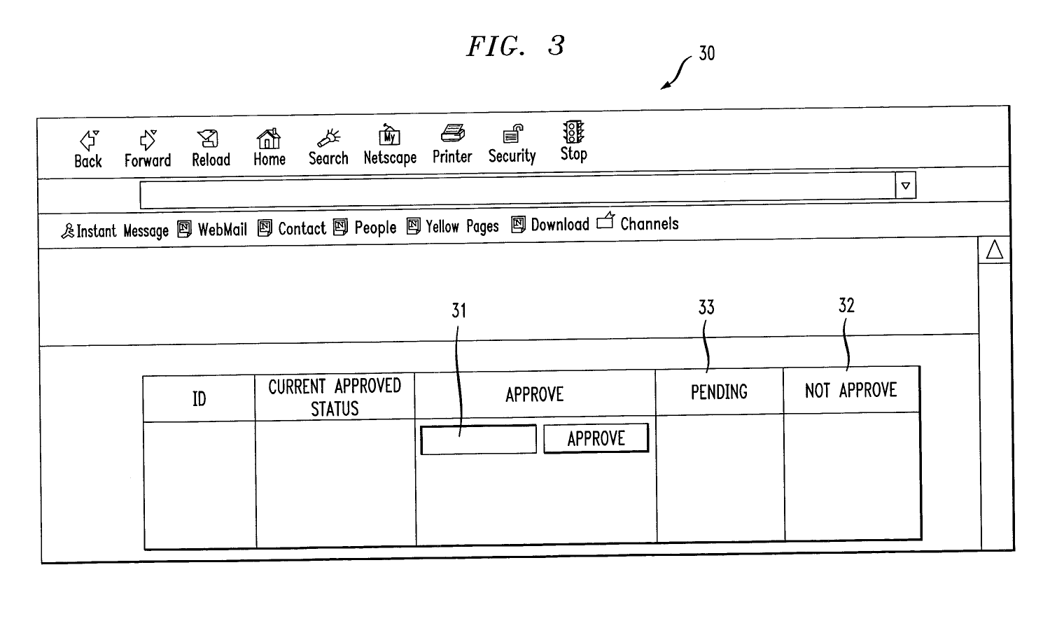

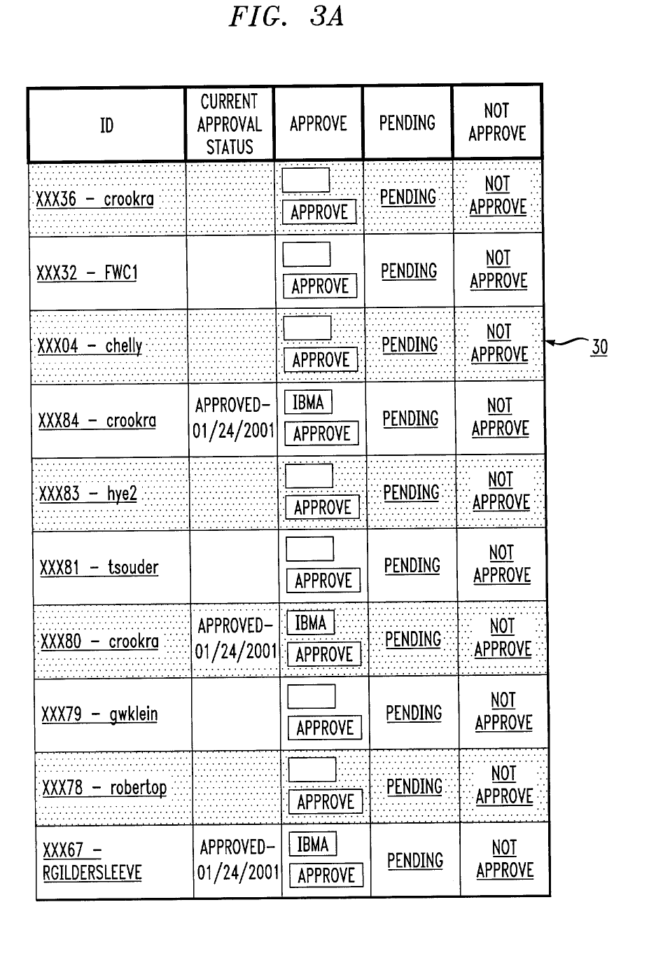

After employee 11 submits form 12 into the database for review by first approver 13, an Email is sent to approver 13 informing approver 13 that a decision must be made and directing the approver to the approval screens 30 shown in FIGS. 3 and 3A.

FIG. 5 is an embodiment of the Email that is sent to approver 13 and to subsequent approvers. It tells approver 13 that there is a request awaiting his/her decision, asks the approver to review the request and if acceptable to approve the request, or if not acceptable, to deny the request with an explanation. It also tells the approver how to access form 12 and further tells approver not to reply to originating employee 11 because the response is automated.

When the approver views approval screen 30, the approver can decide to approve the request 31, not approve the request 32, or put the request into a pending mode 33. If approver 13 approves the request, the database automatically sends an Email to the next approver in accordance with the preselected approval process designated by department selection 28. FIG. 3A is an expanded version of approval screen 30. It shows the status of all of the decisions which have been made, or which need to be made, by a particular approver. For example, FIG. 3A shows that the approver has made a decision on a request from Gildersleeve, but has not made a decision on a request from Souder.

If approver 13, or any subsequent approver, decides not to approve the request, or if the approver puts the request in a pending status, the approver is required to enter a reason for the decision. The reason for non-approval is included in an Email back to the originating employee 11 who may make changes to form 12 and resubmit the request for approval. When the request is resubmitted with additional information, the approval process begins with the approver who rejected the request.

As each approver issues an approval and the next approver is notified of the need to make a decision, each subsequent approver has the same three decision choices: approve, not approve, pending. As before, an approval decision sends the request to the next level of approval. A non-approval results in an Email being sent to the originator of the request 11 who is then given the opportunity to make modifications and restart the approval sequence at the point of rejection. The pending notification also notifies the originator 11 who may then make modifications. At that point, the approval process picks up where it left off.

FIG. 1 shows five approval levels. It will be understood by those skilled in the art that the approval process may have more, or less, than five levels of approvals, depending upon the chain and the department identification. However, no matter how many management levels are involved, each level operates the same way. Approvers are notified of any action required by them via Email and are directed to their approval modules. Each module has the same three options for the approver: approve, not approve, pending.

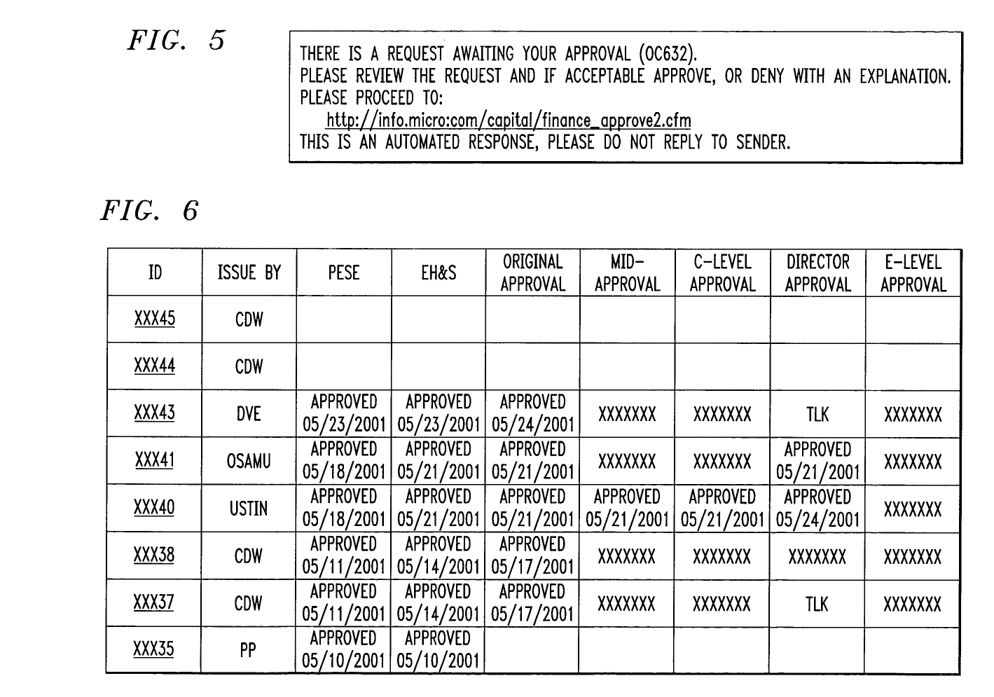

During the approval process, the originating employee 11 can determine the status of the request in the approval chain by viewing the embodiment of a screen identified as FIG. 6. FIG. 6 shows all of the necessary approvers, shows which approvals are required, which approvals are not required, and shows the current approval status of each approver. In FIG. 5, “xxxxx” shows approval levels not required and blank spaces mean that the required approvers have not made a decision yet.

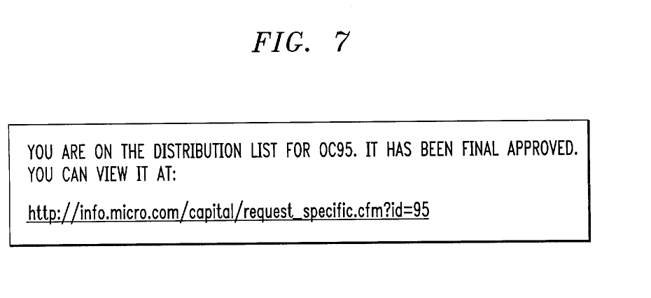

If the request makes it through all levels of approval, the originating employee 11 and each person on the list of recipients are notified that the request has been approved. FIG. 7 is an embodiment of a form which tells the originating employee 11 and each person on the list of recipients that the request has been approved and telling each person where to view the final approval, if desired.

It is understood that the present invention is susceptible to many different variations and combinations and is not limited to the specific embodiments shown in this application. In addition, it should be understood that each of the elements disclosed all do not need to be provided in a single embodiment, but rather can be provided in any desired combination of elements where desired. It will also be appreciated that a system in accordance with the invention can be constructed in whole or in part from special purpose hardware or from conventional general purpose hardware or any combination thereof, any portion of which may be controlled by a suitable program. Any program may in whole or in part be comprised of or be stored on a system in a conventional manner, or remain whole or in part be provided into the system over a network or other mechanism for transferring information in a conventional manner. Accordingly, it is understood that the above description of the present invention is susceptible to considerable modifications, changes, and adaptations by those skilled in the art and that such modifications, changes and adaptations are intended to be considered within the scope of the present invention, which is set forth by the appended claims.

We claim:

1. A method for centralizing the capital expenditure approval process for expenditures by employees in the various departments of a company comprising the steps of:
a) identifying a defined number of departments within the company;
b) determining factors which must be considered as a prerequisite
to the approval of capital expenditures sought by employees in each department;
c) using the factors to determine a defmed number of levels of approvals required for each capital expenditure;
d) creating a database for the online computer system which stores
the identification of the departments, the factors to be considered, and the requisite levels of approvals;
e) inputting into the online system information about a desired expenditure including the department which wants to incur the expenditure, and the factors pertaining to said expenditure;
f) using the online computer system to compare the inputted department identification and said created inputted factors with the database and generating a table of requisite approvers for said expenditure; and
g) electronically routing the inputted information to each of said requisite approvers.

2. The method of claim 1 wherein the step of identifying a defined number of departments includes the step of identifying all of the departments.

3. The method of claim 1 wherein the factors which must be considered are the nature of the item to be purchased and the cost of the item.

4. The method of claim 1 wherein the inputted information is routed to the requisite approvers in a sequential manner.

5. The method of claim 1 wherein the method is performed by a computer system.

6. The method of claim 1 wherein the method is incorporated into software.

7. The method of claim 1 wherein the method is performed in a computer system.

8. A method used in a computer system for centralizing the capital expenditure approval process for expenditures by employees in the various departments of a company comprising the steps of:
a) identifying a defined number of departments within the company;
b) determining factors which must be considered as a prerequisite
to the approval of capital expenditures sought by employees in each department;
c) using the factors to determine a defined number of levels of approvals required for each capital expenditure;
d) creating a database for the online computer system which stores
the identification of the departments, the factors to be considered, and the requisite levels of approvals;
e) inputting into the online system information about a desired expenditure including the department which wants to incur the expenditure, and the factors pertaining to said expenditure;
f) using the online computer system to compare the inputted department identification and said created inputted factors with the database and generating a table of requisite approvers for said expenditure; and
g) electronically routing the inputted information to each of said requisite approvers.

9. The method of claim 8 wherein the step of identifying a defined number of departments includes the step of identifying all of the departments.

10. The method of claim 8 wherein the factors which must be considered are the nature of the item to be purchased and the cost of the item.

11. The method of claim 8 wherein the inputted information is routed to the requisite approvers in a sequential manner.

12. A computer system for centralizing the capital expenditure approval process for expenditures by employees in the various departments of a company comprising one or more computers and computer readable code embodying instructions executable by the one or more computers, the computer system comprising computer readable code devices configured to cause the one or more computers to effect the
a) identification of a defined number of departments within the company;
b) determination of factors which must be considered as a prerequisite to the approval of capital expenditures sought by employees in each department;
c) use of the factors to determine a defined number of levels of approvals required for each capital expenditure;
d) creation of a database for the online computer system which stores
the identification of the departments, the factors to be considered, and the requisite levels of approvals;
e) inputting into the online system information about a desired expenditure including the department which wants to incur the expenditure, and the factors pertaining to said expenditure;
f) use of the online computer system to compare the inputted department identification and said created inputted factors with the database and generating a table of requisite approvers for said expenditure; and
g) electronic routing the inputted information to each of said requisite approvers.

13. The computer system of claim 12 wherein the identification of a defined number of departments includes the identification of all of the departments.

14. The computer system of claim 12 wherein the factors which must be considered are the nature of the item to be purchased and the cost of the item.

15. The computer system of claim 12 wherein the inputted information is routed to the requisite approvers in a sequential manner.

16. A computer data signal embodied in a transmission medium for centralizing the capital expenditure approval process for expenditures by employees in the various departments of a company, the computer data signal comprising a code segment including instructions for
a) identifying a defined number of departments within the company;
b) determining factors which must be considered as a prerequisite to the approval of capital expenditures sought by employees in each department;
c) using the factors to determine a defined number of levels of approvals required for each capital expenditure;
d) creating a database for the online computer system which stores the identification of the departments, the factors to be considered, and the requisite levels of approvals;
e) inputting into the online system information about a desired expenditure including the department which wants to incur the expenditure, and the factors pertaining to said expenditure;
f) using the online computer system to compare the inputted department identification and said created inputted factors with the database and generating a table of requisite approvers for said expenditure; and
g) electronically routing the inputted information to each of said requisite approvers.

17. The computer data signal of claim 16 wherein the instructions for identifying a defined number of departments include instructions for identifying all of the departments.

18. The computer data signal of claim 16 wherein the factors which must be considered are the nature of the item to be purchased and the cost of the item.

19. The computer data signal of claim 16 wherein the inputted information is routed to the requisite approvers in a sequential manner.
